(19) United States
(12) Patent Application Publication
(10) Pub. No.: US 2011/0302837 A1
(43) Pub. Date: Dec. 15, 2011

(54) Ecological Cloth Structure for Cultivating Plants

(76) Inventor: Shun-I Chen, Dong Guan City (CN)

(21) Appl. No.: 12/814,525

(22) Filed: Jun. 14, 2010

(51) Int. Cl. A01G 9/02; B32B 1/00; B32B 3/10; B32B 27/12; B32B 5/26; B32B 3/06

(52) U.S. Cl. 47/65.8; 442/327; 428/99; 428/137; 442/395; 442/394; 442/396; 442/268; 428/35.6

(57) ABSTRACT

A cloth structure includes a cloth body including a non-woven cloth layer, a water absorbing cotton layer bonded onto the non-woven cloth layer, and a waterproof film layer bonded onto the water absorbing cotton layer. Thus, the cloth body is directly hung on the vertical wall so that the cloth structure can be used to cultivate the plants directly without having to occupy the land so as to reduce usage of the land and to save the cost of cultivation largely.

### BACKGROUND OF THE INVENTION

1. Field of the Invention

The present invention relates to a cloth structure and, more particularly, to an ecological cloth structure for cultivating plants.

2. Description of the Related Art

A conventional vase or pot can be used to cultivate a plant. However, it is necessary to provide many vases or pots to cultivate multiple plants, thereby increasing the cost of cultivation. In addition, the vases or pots occupy a larger space, so that it is necessary to provide enough space to cultivate the plants. The plants can also be planted in the land. However, the cultivating land in the city is small and expensive, thereby limiting the cultivating area of the plants, and thereby increasing the cost of cultivation.

### BRIEF SUMMARY OF THE INVENTION

In accordance with the present invention, there is provided a cloth structure, comprising a cloth body including a non-woven cloth layer, a water absorbing cotton layer bonded onto the non-woven cloth layer, and a waterproof film layer bonded onto the water absorbing cotton layer.

The primary objective of the present invention is to provide an ecological cloth structure that can be used for cultivating plants.

According to the primary advantage of the present invention, the cloth body is directly hung on the vertical wall so that the cloth structure can be used to cultivate the plants directly without having to occupy the land so as to reduce usage of the land and to save the cost of cultivation largely.

According to another advantage of the present invention, the cloth structure has a spraying pipe whose spraying nozzles are located above the water absorbing cotton layer so that the water from the spraying nozzles of the spraying pipe flows downward to permeate and wet the water absorbing cotton layer and the non-woven cloth layer gradually so as to save the water resource.

According to a further advantage of the present invention, the non-woven cloth layer is located at two opposite side of the cloth body to increase the cultivating area of the cloth body.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially cut-away perspective view of a cloth structure in accordance with the preferred embodiment of the present invention.

FIG. 2 is a partially cut-away perspective view of a cloth structure in accordance with another preferred embodiment of the present invention.

FIG. 3 is a partially cut-away perspective view of a cloth structure in accordance with another preferred embodiment of the present invention.

### DETAILED DESCRIPTION OF THE INVENTION

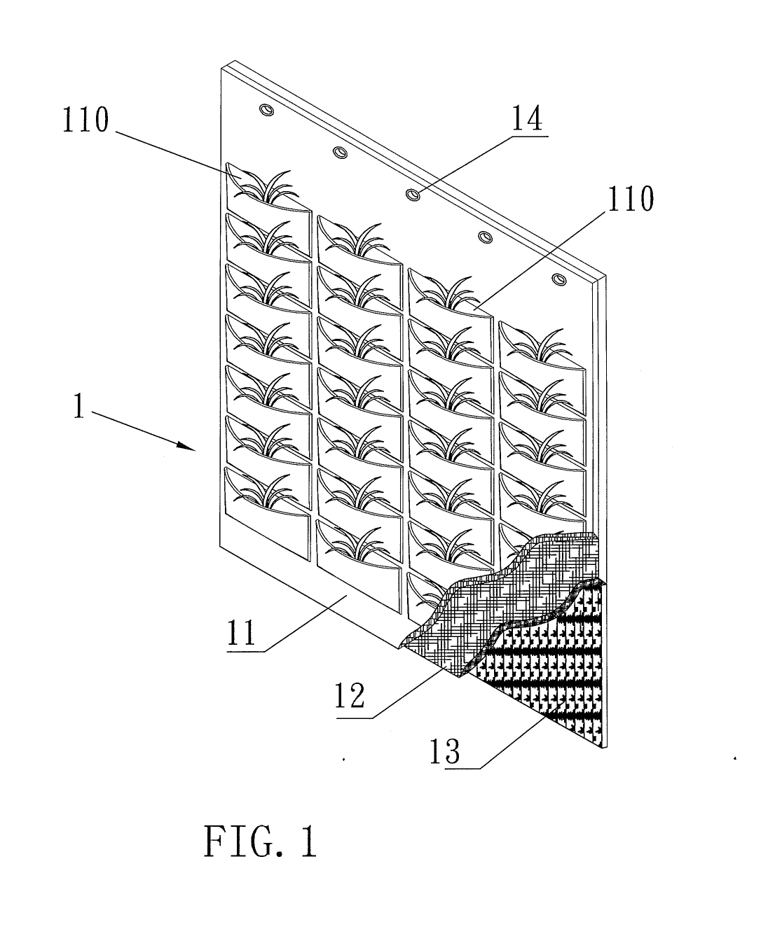

Referring to the drawings and initially to FIG. 1, a cloth structure in accordance with the preferred embodiment of the present invention comprises a cloth body 1 and a plurality of hanging members 14 mounted on the cloth body 1 to attach the cloth body 1 to a determined position of an object, such as a vertical wall and the like.

The cloth body 1 includes a non-woven cloth layer 11, a water absorbing cotton layer 12 bonded onto the non-woven cloth layer 11, and a waterproof film layer 13 bonded onto the water absorbing cotton layer 12.

The non-woven cloth layer 11 is located at one side of the cloth body 1. The non-woven cloth layer 11 has a first side provided with a plurality of pockets 110 to receive plants and cultivating soil therein. The non-woven cloth layer 11 is flexible, tensile resistant and ventilating and can prevent the soil from being lost.

The water absorbing cotton layer 12 is sandwiched between the non-woven cloth layer 11 and the waterproof film layer 13 and has a first side bonded onto a second side of the non-woven cloth layer 11. The water absorbing cotton layer 12 can absorb and supply water to the non-woven cloth layer 11 so as to water the soil and cultivate the plants in the pockets 110 of the non-woven cloth layer 11.

The waterproof film layer 13 is bonded onto a second side of the water absorbing cotton layer 12 to prevent the water in the water absorbing cotton layer 12 from being lost. The waterproof film layer 13 is ventilating to provide a ventilating effect to the water absorbing cotton layer 12 and the non-woven cloth layer 11. Preferably, the waterproof film layer 13 is made of PET (polyethylene terephthalate), TPU (thermoplastic polyurethane), PVC (polyvinyl chloride), EVA (ethyl vinyl acetate) or carbon fiber woven cloth.

Each of the hanging members 14 is a rivet extending through an upper end of the cloth body 1 or a hanging hole formed in an upper end of the cloth body 1.

In practice, the cloth body 1 is attached to a determined position of an object, such as a vertical wall, by the hanging members 14. Then, water is sprinkled onto the cloth body 1 so that the water absorbing cotton layer 12 can absorb and supply the water to the non-woven cloth layer 11 so as to water the soil and cultivate the plants in the pockets 110 of the non-woven cloth layer 11. In such a manner, the cloth body 1 is directly hung on the vertical wall so that the cloth structure can be used to cultivate the plants without having to occupy the land so as to save the cost of cultivation largely.

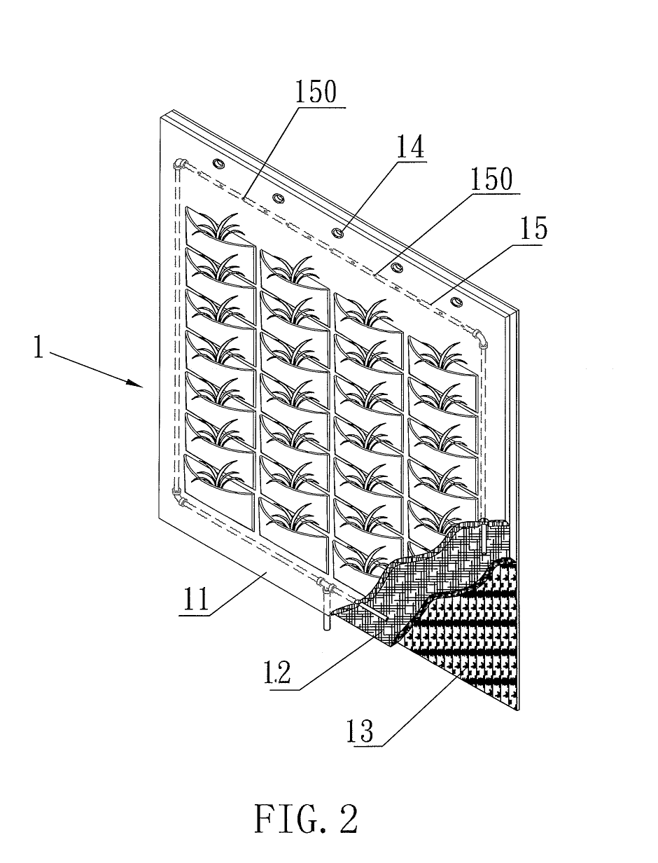

Referring to FIG. 2, the cloth structure further comprises a spraying pipe 15 mounted on the cloth body 1 to spray water to the cloth body 1 so as to supply water into the water absorbing cotton layer 12 of the cloth body 1. The spraying pipe 15 is mounted on a periphery of the cloth body 1 and has a plurality of spraying nozzles 150 located above the non-woven cloth layer 11 and the water absorbing cotton layer 12 of the cloth body 1.

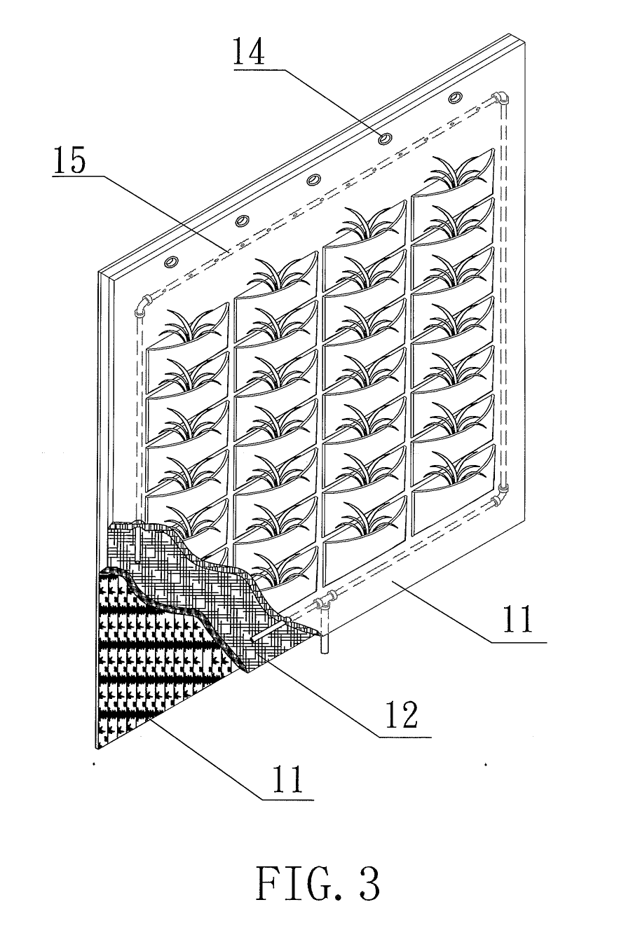

Referring to FIG. 3, the non-woven cloth layer 11 is located at two opposite side of the cloth body 1 to increase the cultivating area of the cloth body 1.

Accordingly, the cloth body 1 is directly hung on the vertical wall so that the cloth structure can be used to cultivate the plants directly without having to occupy the land so as to reduce usage of the land and to save the cost of cultivation largely. In addition, the cloth structure has a spraying pipe 15 whose spraying nozzles 150 are located above the water absorbing cotton layer 12 so that the water from the spraying nozzles 150 of the spraying pipe 15 flows downward to permeate and wet the water absorbing cotton layer 12 and the non-woven cloth layer 11 gradually so as to save the water resource. Further, the non-woven cloth layer 11 is located at two opposite side of the cloth body 1 to increase the cultivating area of the cloth body 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cloth structure, comprising:
a cloth body including a non-woven cloth layer, a water absorbing cotton layer bonded onto the non-woven cloth layer, and a waterproof film layer bonded onto the water absorbing cotton layer.

2. The cloth structure of claim 1, wherein the cloth structure further comprises:
a plurality of hanging members mounted on the cloth body.

3. The cloth structure of claim 1, wherein the non-woven cloth layer is located at one side of the cloth body.

4. The cloth structure of claim 1, wherein
the non-woven cloth layer has a first side provided with a plurality of pockets;
the water absorbing cotton layer has a first side bonded onto a second side of the non-woven cloth layer;
the waterproof film layer is bonded onto a second side of the water absorbing cotton layer.

5. The cloth structure of claim 1, wherein the water absorbing cotton layer is sandwiched between the non-Woven cloth layer and the waterproof film layer.

6. The cloth structure of claim 1, wherein the waterproof film layer is made of PET (polyethylene terephthalate).

7. The cloth structure of claim 1, wherein the waterproof film layer is made of TPU (thermoplastic polyurethane).

8. The cloth structure of claim 1, wherein the waterproof film layer is made of PVC (polyvinyl chloride).

9. The cloth structure of claim 1, wherein the waterproof film layer is made of EVA (ethyl vinyl acetate) or carbon fiber woven cloth.

10. The cloth structure of claim 2, wherein each of the hanging members is a rivet extending through an upper end of the cloth body.

11. The cloth structure of claim 2, wherein each of the hanging members is a hanging hole formed in an upper end of the cloth body.

12. The cloth structure of claim 1, wherein the cloth structure further comprises:
a spraying pipe mounted on the cloth body to spray water to the cloth body so as to supply water into the water absorbing cotton layer of the cloth body.

13. The cloth structure of claim 12, wherein the spraying pipe has a plurality of spraying nozzles located above the non-woven cloth layer and the water absorbing cotton layer of the cloth body.

14. The cloth structure of claim 12, wherein the spraying pipe is mounted on a periphery of the cloth body.

15. The cloth structure of claim 1, wherein the non-woven cloth layer is located at two opposite side of the cloth body to increase a cultivating area of the cloth body.
